(19) United States
(12) Patent Application Publication
(10) Pub. No.: US 2016/0292695 A1
(43) Pub. Date: Oct. 6, 2016

(54) System and method for authenticating a signature on a comic book for grading and encapsulation

(71) Applicant: Michael Bornstein, Bellaire, TX (US)

(72) Inventor: Michael Bornstein, Houston, TX (US)

(21) Appl. No.: 14/794,686

(22) Filed: Jul. 8, 2015

Related U.S. Application Data
(63) Continuation-in-part of application No. 14/628,390, filed on Feb. 23, 2015.
Application No. 14/628,390 is a continuation-in-part of application No. 14/637,892, filed on Mar. 4, 2015.
Application No. 14/637,892 is a continuation-in-part of application No. 14/642,077, filed on Mar. 9, 2015.
(60) Provisional application No. 62/090,259, filed on Dec. 10, 2014.
(60) Provisional application No. 62/082,914, filed on Nov. 21, 2014.

(51) Int. Cl. G06Q 30/00; G06Q 30/02; B42D 3/08

(52) U.S. Cl. CPC G06Q 30/018; B42D 3/08; G06Q 30/0278

(57) ABSTRACT

A system and method for grading a document are disclosed, the method including but not limited to generating on a comic grading processor, a grade for a first comic book using grading notes for the first comic book from a first comic book grader; generating a quick scan code for the grading notes; accepting at the comic grading processor, a Quick Scan code from a mobile device; and sending from the comic book grading processor to the mobile device a grading report comprising the grade and grading notes indicated by the quick response code. A system is disclosed for practicing the method.

### CROSS REFERENCE TO RELATED APPLICATIONS

This patent application is a continuation in part of U.S. patent application Ser. No. 14/642,077 filed on Mar. 9, 2015, and entitled A System and Method for Accessing Comic Book Grading Notes via a Quick Scan Code, and bases priority on U.S. patent application number 14 and bases priority from the following patent applications: US Provisional patent application entitled A System and Method for Encapsulating a Comic Book By Michael Bornstein Ser. No. 62/090,259 filed on Dec. 10, 2014; US Provisional patent application entitled A System and Method for Encapsulating a Comic Book By Michael Bornstein Ser. No. 62/082,914 filed on Nov. 21, 2014; and U.S. patent application Ser. No. 14/628,390 filed on Feb. 23, 2015 entitled A System and Method for Encapsulating a Comic Book By Michael Bornstein; and U.S. patent application Ser. No. 14/637,892 filed on Mar. 4, 2015 and entitled, A System and Method for Verifying a Signature by Michael Bornstein, and A System and U.S. patent application Ser. No. 14/725,758 filed on May 29, 2015 by Michael Bornstein and entitled, Method for Authenticating a Signature on a Comic Book for Grading and Encapsulation all of which are incorporated by reference herein in their entirety.

### BACKGROUND OF THE INVENTION

Comic book collecting has rapidly grown from nothing more than a child's hobby to a substantial section of the collectables market. There is a need to reliably grade these collectibles.

### SUMMARY OF THE INVENTION

A system and method for grading a document are disclosed, the method including but not limited to generating on a comic grading processor, a grade for a first comic book using grading notes for the first comic book from a first comic book grader; generating a quick scan code for the grading notes; accepting at the comic grading processor, a Quick Scan code from a mobile device; and sending from the comic book grading processor to the mobile device a grading report comprising the grade and grading notes indicated by the quick response code. A system is disclosed for practicing the method.

### BRIEF DESCRIPTION OF THE DRAWINGS

The Figures are provided to show examples of different embodiments of the invention.

FIG. 1 is schematic representation of an illustrative embodiment of the invention showing system for grading a comic book;

FIG. 2-4 are flow chart representations of illustrative embodiments of the showing light spectra verification;

FIG. 5 is a depiction of a data structure used by the comic book processor in an illustrative embodiment of the invention;

FIG. 6 is a flow chart schematic representation of the invention showing a method for authenticating a signature on a comic book; and

FIG. 7 is a schematic depiction of an illustrative embodiment of the invention showing a comic book with an authenticated signature encapsulated in a case.

### DETAILED DESCRIPTION OF THE INVENTION

In an exemplary embodiment a system and method are disclosed in which a signature on a comic book is authenticated to be a signature that it is purported to be, that is, the signature a comic book artist, for example the signature “Stan Lee” is authenticated to have been actually signed by Stan Lee. In another embodiment, the signature “Stan Lee” is authenticated to have been actually signed by Stan Lee's authorized proxy. In another embodiment, the signature authentication process is any process now known or unknown for authenticating a signature. In another embodiment the authentication process is performed by a human handwriting analyst to confirm that the purported signature is the signature of the person whom it is purported to be. A comic book is more valuable when a signature on the comic has been authenticated. A comic book grade is increased when a signature on the comic has been authenticated.

In another embodiment the authentication process is performed by a human handwriting analyst comparing a signature to be authenticated to a reference sample of the signature to confirm that the purported signature is the signature of the person whom it is purported to be. In another embodiment the signature is authenticated by a process and system described in the co-pending U.S. patent application Ser. No. 14/637,892 filed on Mar. 4, 2015 and entitled, A System and Method for Verifying a Signature by Michael Bornstein. In another embodiment a system and method are disclosed in which a comic book signature is authenticated by any known method and apparatus and is encapsulated by any known or unknown method and apparatus. In another embodiment a system and method are disclosed in which a comic book signature is authenticated by any known method and apparatus and is encapsulated as disclosed in U.S. patent application Ser. No. 14/628,390 filed on Feb. 23, 2015 entitled A System and Method for Encapsulating a Comic Book by Michael Bornstein. In another embodiment a system and method are disclosed in which a comic book signature is authenticated by any known method and apparatus and is encapsulated by any known or unknown method and apparatus and graded by any know or unknown method and apparatus. In another embodiment a system and method are disclosed in which a comic book signature is authenticated by any known or unknown method and the comic book on which the signature appears is graded as described in U.S. patent application Ser. No. 14/642,077 filed on Mar. 9, 2015, and entitled A System and Method for Accessing Comic Book Grading Notes via a Quick Scan Code. In another embodiment a system and method are provided in which a comic book signature is authenticated by any known or unknown method and the comic book on which the signature appears is graded by any known or unknown method. In another embodiment a system and method are provided in which a comic book signature is authenticated by any known or unknown method and the comic book on which the signature appears is encapsulated by any known or unknown method.

In another exemplary embodiment of the invention a method is provided including but not limited to the act of authenticating a signature on a comic book. In another exemplary embodiment of the invention a method is provided including but not limited to the act of encapsulating the comic book after the authenticating the signature on the comic book. In another exemplary embodiment of the invention a method is provided including but not limited to the act of grading the comic book. In another exemplary embodiment of the invention a method is provided including but not limited to the act of encapsulating the comic book after authenticating and grading the comic book. In another exemplary embodiment of the invention a method is provided including but not limited to the act of encapsulating the comic book after grading the comic book.

In another embodiment an apparatus are disclosed including but not limited to a comic book having a verified signature. In another embodiment the system and apparatus further include a case in which the comic book is encapsulated.

The authenticated signature is the result of a process in which an expert Collectable comic books have become rare and expensive, exceeding $100,000 in value. The collectors take their “hobby” very seriously. Thus, grading and authentication of the comic books becomes essential to determine a reliable value for a particular comic book. The primary reason to grade a comic is that there is a direct correlation between the condition of the comic book as indicated by the grade and the value of the comic book. Of course, the comic book grade has more value when a buyer has confidence that the comic book or document is what is held out to be. Comic books have become so valuable that fraudulent representation of counterfeit comic books is a risk associated with purchase of an expensive comic book. Also, when the comic book is autographed, it is more valuable when the signature is verified to be what it is held out to be.

The primary reason to grade a comic is that there is a direct correlation between the condition of the comic book and the value of the comic book. The higher the grade of a comic book is, in many cases, the higher the value will be. To grade a comic you need to take into consideration a number of factors before being able to assess the correct grade. When initially looking at a comic book the first thing one will notice is the cover of the book. The cover of a comic is what typically takes the most abuse. Any amount of wear to the cover of the hook must be factored into the condition on and grading of the comic. This can include abrasions, tears, creases, bent corners, spine splits, chips, tape, stains and a multitude of other types of wear that we will cover in the grades noted below.

Comic book graders take into account of numerous factors in their grading notes in arriving a grade. One of the most important factors comic book grader does is first to count the interior pages. In a particular embodiment, the comic book is compared to a digital reference image of the complete comic book to ensure that all pages are intact. An incomplete book missing pages will have significantly less value than a complete copy. There are also a wide variety of other possible defects to the interior of a comic book that can lower the overall grade. These can include missing pieces of pages, clipped coupons, tears, tape, loose centerfold pages, insect damage, among other defects. In a particular embodiment, the comic book is compared to a digital reference image of the complete comic book to ensure that all pages are intact. Also, very important is the quality of the paper commonly referred to as “page quality”. In a particular embodiment, the comic book is compared to a digital reference image and color of the complete comic book to ensure that all pages are intact and of good quality and color. In a particular embodiment, the comic book is compared to a digital reference image of the complete comic book to ensure that all pages are intact. The deterioration of the quality of the pages is due to aging and or incorrect storage. This can include the pages color changing from its original color of white to cream colored pages or as severely degraded as tan pages with brittleness. In a particular embodiment, the comic book is irradiated with light an analyzed with a spectrometer to determine the quality of the pages is due to aging and or incorrect storage, the pages color changing from its or al color of white to cream colored pages or as severely degraded as tan pages with brittleness. To many, the most desired comics are those with white pages. Many collectors will accept any page quality except for books with slightly brittle or brittle pages in a collectible comic on older comics. Tape is considered a defect and not restoration. Downgrading for tape has been considered a hobby standard for a long time.

Grader profiles Key Factors: It's important to remember that the condition of the comic is just one of several key factors when buying, selling, or trading comics. Others Are: Rarity is one significant factor which can affect the value of a comic. How unusual or how easily replaced the comic might be. Collectors will typically be less inclined to part with a rare book easily. While rarity can significantly affect a book in a positive manner, it is not the only factor in helping to assess value. If a rare book is not in demand within the comic collecting community no amount of rarity will help support the value of the book on its own. Marketability is the demand for the book and the ease of selling your book. Comics with classic covers, first appearances, noted artists, and other types of strong interest front from the collectors market will have more marketability than a common book that has no historical significance. The internet has changed the marketability of many books in the comic book market. Prior to the internet collectors had to purchase their comics either directly from comic dealers at conventions, retail stores, through private transactions, or through mail-order catalogs. In some instances comics that were once viewed as scarce or rare on a local level are now more readily available via the internet. Today, online comic auctions and consignment sites allow comics to be offered and have a more significant presence with larger pool of potential buyers. Keep in mind that the marketability of any comic book can change based on time, the popularity of the character or characters, collector demand, etc.

In rare cases, a comic book will look much better than the given grade. In these rare cases, a Check Mark will be placed on the label by the numerical grade. The best way to understand why a specific comic book received a Check Mark designation is to refer to the graders' notes. Graders examine each comic book and assign a grade. The assigned grade and the grading notes for the grade from the grader for each comic book graded are stored in the non-transitory computer readable medium are generated by each grade.

A grading report is generated for each comic book and each graders. A neural network learns each grader's grading technique by monitoring the grading notes and grade assigned by each grader and capture the grader's tendencies in a profile for each grader. The neural network learns how each grader grades based on the grading notes indicating assigns weights to for each factor to generate a neural network profile of weights that can be used to generate a phantom grade for the grader by inputting grading notes form the grader into the profile for the grader. In a particular embodiment, the grading notes include but are not limited to the examiner's notes indicating the condition of the comic book. The following general neural net weights are assigned to a training set of weights that learns a particular graders tendencies over multiple grading of comic books and generates a profile of each comic hook grader. A composite profile is generated for multiple graders. The graders in the composite profile can be in the same grading company or gathered from graders dispersed in various companies and locations. The following key factors and grade are used to generate an initial training set of weights that are used to train a neural network to learn how a particular grader generates a grade for a comic book based on the grading notes.

Grades at the top are GEM MINT: 10 and MINT: 9.9. In a particular embodiment, The best scores are 9.91-10 which are grades given to a coming having the best possible existing condition of that comic book. An extremely exceptional comic. Only very minute printing and bindery defects or the most barely noticeable handling defects present. It is very rare, especially in older vintage comic books, to discover a comic in these grades as they are virtually non-existent. No autographs or writing is allowed on either the cover or interior pages. Cover inks are exceptionally bright with high gloss. Interior pages must be white in color and supple to the touch.

NEAR MINT/MINT: 9.8 This is close to mint with few minor defects. Interior pages are almost always off-white/white or better.

NEAR MINT +: 9.6 This is close to mint with some minor defects. Even though some defects are allowed in 9.6, certain defects, such as tape, are never allowed in this grade range. Slight stress on the spine. The staples themselves are generally centered clean with no discernible rust. Maybe some minor color has chipped or flaked off the cover. The cover is flat with no surface wear. Inks are bright with high reflectivity and very little fading. Square and sharp corners with ever so slight blunting permitted. You can tell that this comic has been stored properly and looks almost as new as the day it was printed. The smallest amount of creasing. All bindery tears are small. Only some binding and/or printing defects allowed. Cover is fairly well centered and firmly secured to interior pages. Paper is supple and like new. Spine is tight and flat. Unobtrusive date stamps or arrival dates in pencil or ink are acceptable. Many pedigree collection comics have a notation on the cover or the interior of the comic and are considered a bonus to collectors as they help prove the provenance of the comic.

NEAR MINT: 9.4 NEAR MINT −: 9.2 This book is an excellent copy with great eye appeal. It is vibrant with supple pages. The spine may have a couple of very small stress lines that break color. Minor creasing. The spine is almost completely flat. The cover is relatively flat with almost minimal surface wear and the cover inks are generally bright with medium to high reflectivity. The staples may show some discoloration, but it's not too noticeable on first glance. The inside pages and covers usually will be off-white/white, but can be cream/off-white with the absence of other defects.

VERY FINE/NEAR MINT: 9.0; VERY FINE +: 8.5; VERY FINE: 8.0: VERY FINE −7.5; A VERY FINE comic book appears to have been read a few times and has been handled with care. These grades allow for some more defects than higher grades. Overall an above average copy and still very collectible. Some of the above defects along with a fold or crease in the cover that breaks color. Some stress marks on spine. A few small chips on the cover. The cover has some slight surface wear but still has much of its original gloss and there is nothing major wrong with it. Sun shadows, dust shadows and tanning can be darker and have more of a visual impact than those in higher grades.

FINE/VERY FINE: 7.0; FINE +: 6.5; FINE: 6.0; FINE −: 5.5 This comic is definitely a read copy with handling wear, but can still be a very desirable copy. This could have one major defect like a larger piece out of the cover, a long tear or a detached centerfold. It has stress lines on the spine and creases from the opening and closing of the cover. This could have a light reading or subscription crease or a rolled spine, but is not damaged enough to reduce eye appeal dramatically. Some cover discoloration, fading in colors and soiling is allowed. The cover and/or inside pages could have some tears and/or folds. With the absence of many other defects, the cover can be detached from one staple, but cover cannot be completely detached from interior. Books with slightly brittle pages cannot grade higher than 6.5 and generally are even lower in grade. Pages and inside covers could be brownish but not brittle. Depending on the look of the comic, very small amounts of tape could be acceptable in this grade.

VERY GOOD/FINE: 5.0; VERY GOOD +: 4.5; VERY GOOD: 4.0; VERY GOOD −: 3.5 Book is complete, but can have major creases and a spine roll. Cover gloss can be very low or sometimes no gloss at all. The inside paper quality can be low and small pieces of the pages may be missing. Books with brittle pages cannot grade higher than 3.5 and generally are even lower in grade. Books in this grade are almost always creased, scuffed, abraded and soiled, but readable. A larger amount of tape is also allowed in this grade. (does not recommend placing tape on a comic).

GOOD/VERY GOOD: 3.0; GOOD +: 2.5: GOOD: 2.0; GOOD −: 1.8 A comic book that is still readable with numerous defects. All the defects of a VG comic with more significant wear. The inside paper quality might not be good and pieces of the pages may be missing. Books in this grade are almost always creased, scuffed, abraded and soiled, but readable. Large pieces can be missing from the cover. Long or many spine splits are possible. The cover and pages many be detached but not missing and is still in a “collectible” grade. A significant amount of tape may have been applied to cover and pages. Book may be fragile.

FAIR/GOOD: 1.5; FAIR: 1.0 This book has seen much better days and tends to be heavily worn and tattered. A copy of a comic in this grade has all pages and most of the covers. A book in this condition is worn, ragged and unattractive. Heavy creases and folds are prevalent. Paper quality can be very low. The spine and/or cover may be completely split. Staples may be missing. Coupons cut from cover and or inside pages. Panels can be clipped out. Parts of the front cover may be missing. Soiling, staining, tears, markings or chunks missing will interfere with reading. Brittleness may be a factor. Extensive amounts of tape are acceptable on the comic in these grades.

POOR: 0.5 It has major defects to the point that there is almost no collector value. Copies in this grade typically will have pages and/or the front cover or back cover may be missing. They may have severe strains or heavy cover abrasions to the point where cover inks are gone. Heavy defacing with paints, varnishes, glues, oil, indelible markers or dyes, etc. The inside pages can have extreme brittleness.

INCOMPLETE 0.3 & 0.1 (Covers/Coverless/Single Wraps or Pages) These designations are only used for the purpose of authentication. Numerous collectors and comic fans will purchase coverless comics to either read or to obtain a filler copy of a book for their collection. Books that are coverless, but are otherwise complete, receive a grade of 0.3 as will covers missing their interiors. Coverless copies that have incomplete interiors, wraps or single pages will receive a grade of 0.1 as will just front covers or just back covers. Copies in this designation typically will in most cases be beyond collectability to the majority of the hobby. Rare key comics and incomplete pages i.e. centerfolds are considered to be valuable by the collecting community for either restoration purposes or for individuals who just wish to own a piece of comic history.

Grading notes are stored and are accessible via a Quick Scan Code (QSC) or QRC label placed on a comic book case encapsulating the comic book. A QSC or QRC QR code (abbreviated from Quick Response Code) is the trademark for a type of matrix barcode (or two-dimensional barcode) first designed for the automotive industry in Japan. A barcode is a machine-readable optical label that contains information about the item to which it is attached. In a particular embodiment, A QR code uses four standardized encoding modes (numeric, alphanumeric, byte/binary, and kanji) to efficiently store data; extensions may also be used. The QR Code (“QRC”) system became popular outside the automotive industry due to its fast readability and greater storage capacity compared to standard UPC barcodes. Applications include product tracking, item identification, time tracking, document management, and general marketing. A QR code (also referred to herein as a “QRC”) consists of black modules (square dots) arranged in a square grid on a white background, which can be read by an imaging device (such as a camera) and processed using Reed-Solomon error correction until the image can be appropriately interpreted. The required data are then extracted from patterns present in both horizontal and vertical components of the image. The QRC is also referred to herein as “QSC”.

In another embodiment, the grading notes are posted online to help a submitter understand how the grading team came to the consensus of the grade on the QRC label. The grading notes also helps future purchasers of that comic book by notating any “hidden” defects that are factored into the final grade, such as a large tear on an interior page or light stains, that are not noticeable by looking at a comic book while in the case.

Every invoice of comics submitted to the comic book grading system enters the receiving department where each shipment is carefully opened and fully inspected. The comics are checked against the submission order form to ensure all comics are accounted for. A barcode and QRC is generated from your invoice number for your specific order tiers which are tied to your personal account. The barcode and QRC is scanned at every step of the certification process. This insures that the order is always easily tracked through our system at every stage of the process it is at. Each comic in the order will also have a barcode sticker placed on the Mylar or bag it came in, which also allows the comic book grading system to track any single comic in your submission. Most importantly, this also allows your comic book to go through the grading process without the graders knowing who owns the books. This insures impartial grades are given to each and every book submitted. Once receiving has finished processing the books, the comics either enter our secure vault to await grading or brought directly into the grading room.

Before a comic book is graded, it is checked for restoration and conservation by our restoration detection experts. If restoration or conservation is found, comic book grading system will include a list of all the work detected on the label, classifying it as either conserved or restored. The comic book grading system has one classification level for conservation and five levels for restoration; slight, slight/moderate, moderate, moderate/extensive, and extensive. The more restoration that is detected, the higher the level becomes. Once the book has been checked for conservation and restoration, it enters the grading phase. In another particular embodiment, the comic book is compared to a digital reference image of the comic to determine if the comic book has been subjected to conservation and restoration. In another particular embodiment, the comic book is analyzed with a spectrometer to determine if the comic book has been subjected to conservation and restoration.

In a particular embodiment, the comic book grading system, considers conservation anything archival safe added to the comic that helps stop its deterioration, such as sealing a spine split or a non-additive processes that helps stop deterioration, such as staple rust removal. The comic book grading system considers restoration to be any additive process that may enhance the aesthetics of the comic, such as color touch and pieces added. If both conservation and restoration are found, the comic will be certified as restored. The comic book grading system provides one classification level for conservation and five levels for restoration; slight, slight to moderate, moderate, moderate to extensive, and extensive. The more restoration that is detected, the higher the level becomes. The comic book grading system provides five classification levels for restoration; slight, slight to moderate, moderate, moderate to extensive, and extensive. The more restoration that is detected, the higher the level becomes. If a comic has been conserved, the comic book grading system will note any conservation found on the grading notes associated with the comic book via a link to the grading notes and a grading report accessed in the QRC label and will be designated as conserved. If both restoration and conservation have been performed on a comic, the QRC label link will access a grading report that lists both, but the comic will be designated within one of the five levels of restoration in the grading report.

An initial QRC is generated for the invoice and scanned so that all books to be graded then have the initial QRC labels printed. The comic book grading system then makes sure each QRC label matches the assigned comic book code for each book. The QRC label is a link to a grading report that lists all the information about the book such as title, issue number, publisher, artist information, key comments and more. The label also includes very specific information about the particular copy that was submitted, including the assigned numerical grade as well as pedigree, variant, signatures, tape, missing pages, restoration, and any other pertinent information. The books are then sealed into an inner well as an archival safe inner holder. The inner holder, along with the label is then inserted and sealed into a cutting-edge, tamper evident outer case as disclosed on U.S. patent application Ser. No. 14/628,390 filed on Feb. 23, 2015 entitled A System and Method for Encapsulating a Comic Book By Michael Bornstein. Once every book in the invoice is encapsulated the books enter the quality control department. The comic book packaging and encapsulation system is described in co-pending patent application U.S. patent application Ser. No. 14/628,390 filed on Feb. 23, 2015 entitled A System and Method for Encapsulating a Comic Book by Michael Bornstein. In a particular illustrative embodiment, signature and comic book verification data as described in the co-pending patent application U.S. patent application Ser. No. 14/637,892 filed on Mar. 4, 2015 and entitled, A System and Method for Verifying a Signature by Michael Bornstein, are included in the grading report, which is accessed by the QSRC in the database, from a mobile or remote device. The process of “verifying” a signature on a comic book as described in U.S. patent application Ser. No. 14/637,892 is also referred to herein as “authenticating” a signature. The comic book processor the checks each label for spelling mistakes or any other problems in the QRC and grading report. Each encapsulating comic book case is checked to make sure the comic is secure, that the label matches the encapsulated book, as well as being checked for any major scuffs and/or abrasions.

Once the first comic book grader enters the barcode number, it is checked against the invoice and QRC to make sure all the comic books are entered into the system properly. Then each comic book is checked to make sure they are complete, as each page is counted, checking for missing panels, coupons and pieces. A data base of complete digital reference images is used to compare to the comic book being graded. The grader will then take notes of any defects that could affect the books grade or will note any defect that may be hidden or hard to see. The grader will also do another check for restoration and then choose a page quality and a grade from ranging from 0.1 up to 10, with 10 being the highest grade a book can receive. To make sure one grader does not influence another grader, any grade chosen remains hidden from all of the next graders. A final restoration check is performed and a final restoration grade and page quality assigned, which is then compared to the chosen grade to the other grades already assigned to the book. At that time, grading notes that were entered are also reviewed, and additional notes are added if needed. If the grades match, or are reasonably close, the book will receive a final grade. If the grades do not match, the book will be passed to another grader (or even other graders) until a consensus of the final grade has been selected.

In another particular embodiment, the comic books are scanned by the comic book processor and image recognition performed to compare the scanned comic book to a reference image of the comic book. The comic book processor detects key grading factors and assigns grades for a comic book by comparing a comic book being graded to a reference image of the comic book. The data from the spectrometer and verification processor are also used to determine a comic book score by evaluating the key factors, including but not limited to the key factors discussed above that go into grading a comic book. Thus, the comic book processor can automatically analyze a comic book using spectroscopy and image recognition and assign a grade using the neural network.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived there from, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

In a particular illustrative embodiment, a method disclosed for grading a document, the method including but not limited to generating on a comic grading processor, a grade for a first comic book using grading notes for the first comic book from a first comic book grader, generating a quick scan code for the grading notes; accepting at the comic grading processor, a QRC from a mobile device; and sending from the comic book grading processor to the mobile device a grading report comprising the grade and grading notes indicated by the quick response code. In another particular embodiment of the method further includes but is not limited to generating on a neural network on the comic grading processor, a phantom grade for the first comic book based on the grading notes for the first comic book from the first comic book grader and a profile for the first comic book grader, and correlating on the neural network the first comic book grade with the phantom grade for the first comic book grader for the first comic book. In another particular embodiment of the method further includes but is not limited to adjusting the weights for the profile for the first comic book grader in the neural network based on the correlating the first comic book grade based on the correlating the first comic book grade with the phantom grade for the first comic book; and generating on the comic grading processor a confidence verification score for the first comic book grade based on the correlating the first comic book grade with the phantom grade for the first comic book. In another particular embodiment of the method further includes but is not limited to generating on a comic grading processor, a second grade for the first comic book using grading notes for the first comic book from a second comic book grader, generating on a neural network on the comic grading processor, a second phantom grade for the first comic book based on the grading notes for the first comic book from the second comic book grader and a profile for the second comic book grader, and correlating on the neural network the second comic book grade with the second phantom grade for the second comic book grader for the first comic book.

In another particular embodiment of the method further includes but is not limited to adjusting the weights for the profile for the second comic book grader in the neural network based on the correlation; and generating on the comic grading processor a confidence verification score for the second comic book grade based on the correlating the second comic book grade with the second phantom grade for the first comic book. In another particular embodiment of the method further includes but is not limited to generating a composite grade for the first comic book based on the correlation of the first comic book grading notes with the second comic book grading notes; and generating on the comic grading processor a confidence verification score for the composite grade for the first comic book. In another particular embodiment of the method further includes but is not limited to generating on the neural network, a phantom composite score for the first comic book based on a correlation of the first comic book grading notes with the second comic book grading notes; correlating the composite score for the first comic book with the phantom composite score for the first comic book; and generating on the comic grading processor a confidence verification score for the phantom composite grade for the first comic book. In another particular embodiment of the method further includes but is not limited to generating the quick scan code for a grading report for the first comic book, the grading report comprising the grade and grading notes from the first comic book grader, the confidence verification score for the grade from the first comic book grader, the grade and grading notes from the second comic book grader, the confidence verification score for the grade from the second comic book grader, the composite grade and the phantom composite grade; and placing the quick scan code for the grading report on a package for the comic book. In another particular embodiment of the method further includes but is not limited to automatically grading the comic book using the neural network, image recognition and spectrometric analysis.

In another particular embodiment, a system for grading a comic book is disclosed, the system including but not limited to a comic grading processor in data communication with a non-transitory computer readable medium, the computer readable medium containing a computer program for execution by the comic grading processor, the computer program further comprising instructions to generate on a comic grading processor, a grade for a first comic book using grading notes for the first comic book from a first comic book grader, instructions to generate a quick scan code for the grading notes; instructions to accept at the comic grading processor, a QRC from a mobile device; and instructions to send from the comic book grading processor to the mobile device a grading report comprising the grade and grading notes indicated by the quick response code. In another particular embodiment of the system, the computer program further includes but is not limited to instructions to generate on a neural network on the comic grading processor, a phantom grade for the first comic book based on the grading notes for the first comic book from the first comic book grader and a profile for the first comic book grader, and instructions to correlate on the neural network the first comic book grade with the phantom grade for the first comic book grader for the first comic book. In another particular embodiment of the system, the computer program further includes but is not limited to instructions to adjust the weights for the profile for the first comic book grader in the neural network based on the correlating the first comic book grade based on the correlating the first comic book grade with the phantom grade for the first comic book; and instructions to generate on the comic grading processor a confidence verification score for the first comic book grade based on the correlating the first comic book grade with the phantom grade for the first comic book. In another particular embodiment of the system, the computer program further includes but is not limited to instructions to generate on a comic grading processor, a second grade for the first comic book using grading notes for the first comic book from a second comic book grader, instructions to generate on a neural network on the comic grading processor, a second phantom grade for the first comic book based on the grading notes for the first comic book from the second comic book grader and a profile for the second comic book grader, and instructions to correlate on the neural network the second comic book grade with the second phantom grade for the second comic book grader for the first comic book.

In another particular embodiment of the system, the computer program further includes but is not limited to instructions to adjust the weights for the profile for the second comic book grader in the neural network based on the correlation; and instructions to generate on the comic grading processor a confidence verification score for the second comic book grade based on the correlating the second comic book grade with the second phantom grade for the first comic book. In another particular embodiment of the system, the computer program further includes but is not limited to instructions to generate a composite grade for the first comic book based on the correlation of the first comic book grading notes with the second comic book grading notes; and instructions to generate on the comic grading processor a confidence verification score for the composite grade for the first comic book. In another particular embodiment of the system, the computer program further includes but is not limited to instructions to generate on the neural network, a phantom composite score for the first comic book based on a correlation of the first comic book grading notes with the second comic book grading notes; instructions to correlate the composite score for the first comic book with the phantom composite score for the first comic book; and instructions to generate on the comic grading processor a confidence verification score for the phantom composite grade for the first comic book.

In another particular embodiment of the system, the computer program further includes but is not limited to instructions to generate the quick scan code for a grading report for the first comic book, the grading report comprising the grade and grading notes from the first comic book grader, the confidence verification score for the grade from the first comic book grader, the grade and grading notes from the second comic book grader, the confidence verification score for the grade from the second comic book grader, the composite grade and the phantom composite grade; and instructions to place the quick scan code for the grading report on a package for the comic book. In another particular embodiment of the system further includes but is not limited to an image recognition system and spectrometer to automatically grade the comic book and generate grading notes for a particular comic book grader profile, the computer program further comprising instructions to automatically compare a scanned image of the comic book to a reference image using image recognition to generate grading notes indicating the condition of a comic book. In another particular embodiment, the computer program further includes but is not limited to instructions to use the spectrometer to determine age and condition of a comic book.

In another embodiment a method is disclosed, including but not limited to, verifying a signature on a comic book. In another embodiment the method further includes but is not limited to grading the comic book. In another embodiment the method further includes but is not limited encapsulating the comic book. In another embodiment the method further includes but is not limited encapsulating the comic book.

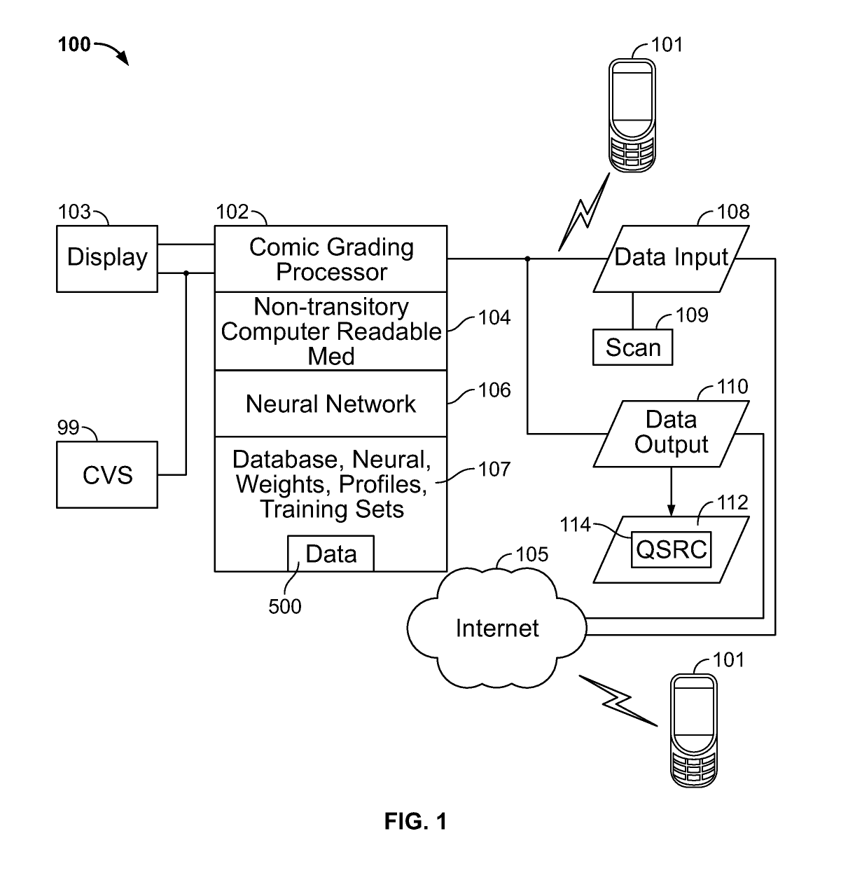

Turning now to FIG. 1, as shown in FIG. 1, an illustrative embodiment of the invention 100 is schematically depicted. In a particular embodiment, the system includes but is not limited to a comic grading processor 102, a verification processor display/interface 103 for a user interface to the comic grading processor, a non-transitory computer readable medium 104, a neural network 106, a database 107, a data input interface 108 for data input from a mobile device such as a smart phone 101 over the internet 105 and data input from a and a verification processor 99 as described in co-pending application Ser. No. 14/637,892 filed on Mar. 4, 2015 and entitled, A System and Method for Verifying a Signature by Michael Bornstein, all of which are incorporated by reference herein in their entirety, a scanner 109 and a data output interface 110 for placing a Quick Scan code (QSC or QRC) 114 on a comic book 112.

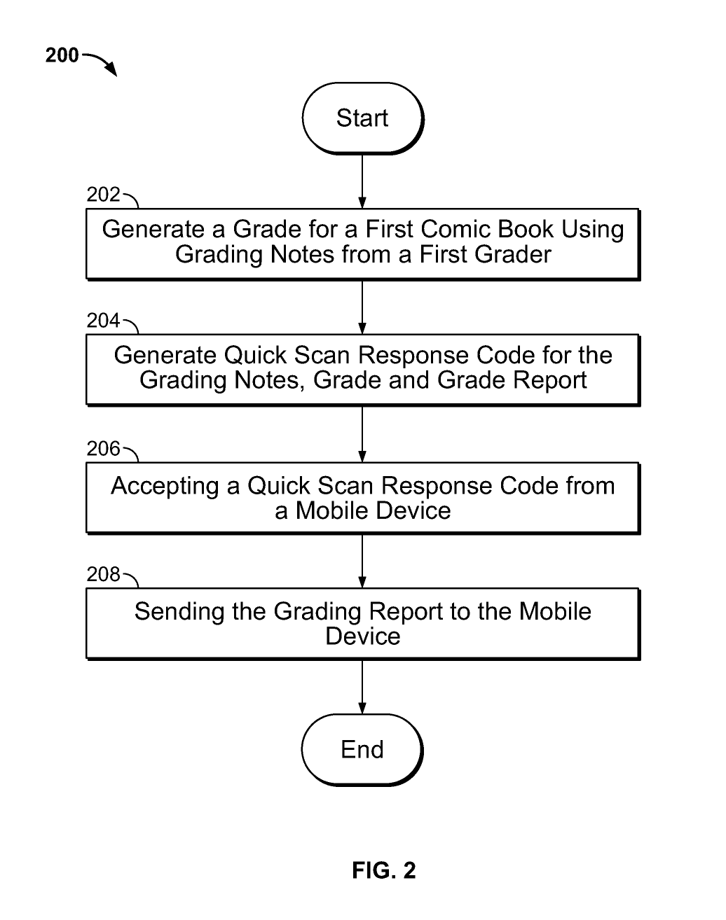

Turning now to FIG. 2, in a particular embodiment 200 of the invention, the comic book grading processor at 202 generates a grade for a first comic book using grading notes from a first comic book grader. In a particular embodiment, the first comic book grader inputs the grading notes and a grade for the first comic book associated with the grading notes into the database 107 using interface 108. In another particular a grade is automatically generated for the first comic book by neural network 106 from the grading notes for the first comic book and a profile for the first comic book grader. In another particular embodiment, the grading notes for the first comic book are automatically generated by the neural network using image recognition and comparing a scan of the first comic book from scanner 109 to a reference image for the first comic book stored in the data base 107. The comic grading processor then generates a Quick Response Code, for the grading notes, the grade and a grade report for the comic book at 204. In block 206 the comic book grading processor accepts a QSC from a mobile device, wherein the QSC is associated with a particular set of grading notes, a grade and a grading report for a particular comic book. In response to the receipt of the QSC.

In a particular embodiment, the QSC is a link to a composite grading report including the QSC and another QSC (a verification QSC) imported to the non-transitory computer readable medium from the Comic Verification System (CVS) 99 system described in U.S. patent application Ser. No. 14/637,892 filed on Mar. 4, 2015 and entitled, A System and Method for Verifying a Signature by Michael Bornstein, all of which are incorporated by reference herein in their entirety. In block 208 the Comic Grading System sends a grading report associated with the QSC received from the mobile device.

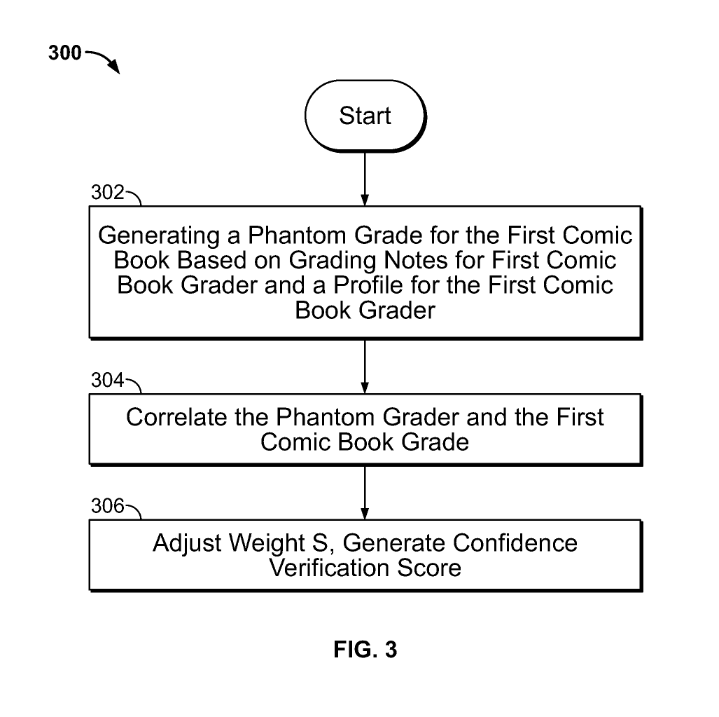

Turning now to FIG. 3, in another illustrative embodiment of the invention 300, the Comic Grading System using the comic grading processor, neural network and a profile for a comic book grader stored in the database to automatically generate a phantom grade for the particular comic book. The phantom grade is generated for the first comic book by the neural network using a profile for the first comic book grader. The neural network then correlates the first comic book grade from the first comic book grader with the phantom grade for the first comic for the first comic book grader. The degree of correlation between the two grades, the actual grade and the phantom grade is stored in the grading report as a confidence verification score for the grade.

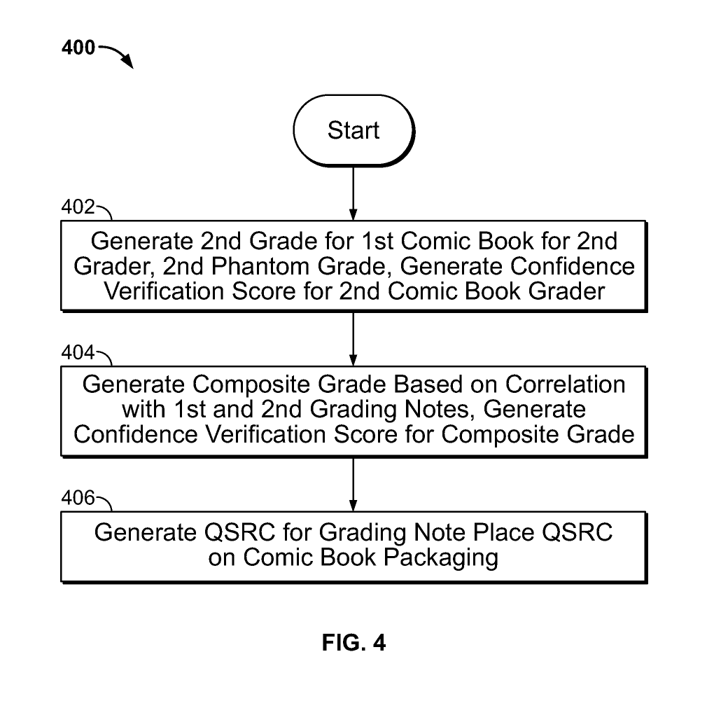

Turning now to FIG. 4, as shown in FIG. 4, in another particular embodiment 400 of the invention, the comic grading processor and neural network generate a second grade for the first comic book for a second comic book grader, a phantom score for the second comic book grader and a verification confidence score for the second grade given by the second comic book grader at block 402. At block 404, the comic book processor generates a composite score for the first comic book based on a correlation of the first and second comic book grading notes, and generates a confidence verification score for the composite grade based on the correlation of the first and second grading notes from the first and second comic book graders. At block 406 the comic grading processor generates a QSC for the grading notes and places the QSC on the package for the first comic book.

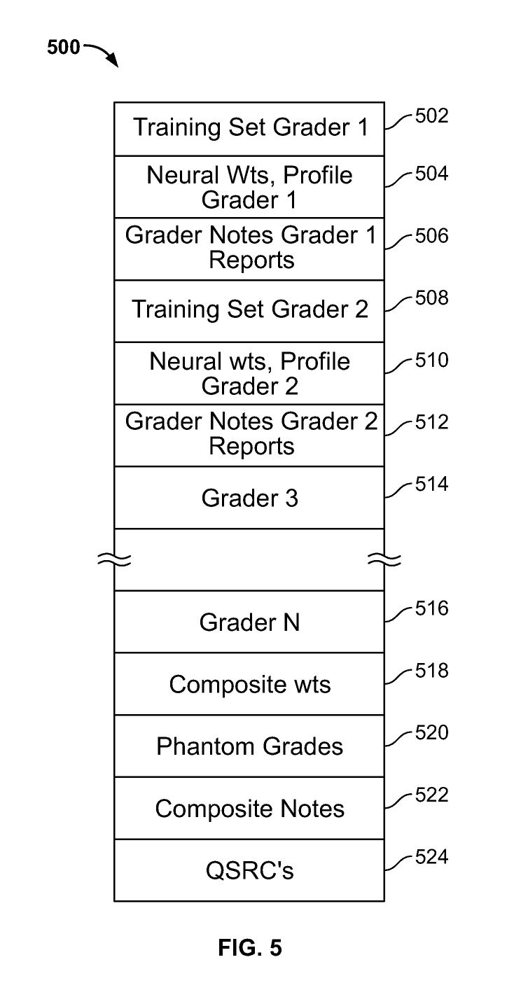

Turning now to FIG. 5, in another embodiment of the invention 500, a data structure of data stored in the non-transitory computer readable medium contains fields for storing data used by the comic grading processor and neural network to grade comics, generate QSC's and send grading reports in response the receipt of a QSC from a mobile device 101 or data input device 108. As shown in FIG. 5, the data structure includes but is limited to a field 502 which contains a training set of data for training the neural network for a first comic book grader, “grader 1”. The data structure further includes but is not limited to the neural weights 504 for the trained neural network that has been trained by the training set of input grading notes and corresponding grades in the profile for grader 1. The data structure further includes but is not limited to 506 grader notes, grades and grade reports for comic book grader 1. The data structure further includes but is not limited to 508 which contains a training set of data for training the neural network for grader 2. The data structure further includes but is not limited to 510 for the trained neural network that has been trained by the training set of input grading notes and corresponding grades in the profile for grader 2. The data structure further includes but is not limited to 512 grader notes, grades and grade reports for comic book grader 2. The data structure further includes but is not limited to 514-516 for grades, grading notes and grading reports for comic book graders 3-N. The data structure further includes but is not limited to 518 for composite grades for each comic book graded by more than one comic book grader. The data structure further includes but is not limited to 520 for phantom grades for the comic books and each comic book graders. The data structure further includes but is not limited to 522 for storing composite notes for each comic book graded. The data structure further includes but is not limited to 524 for storing QSCs generated by the comic grading processor.

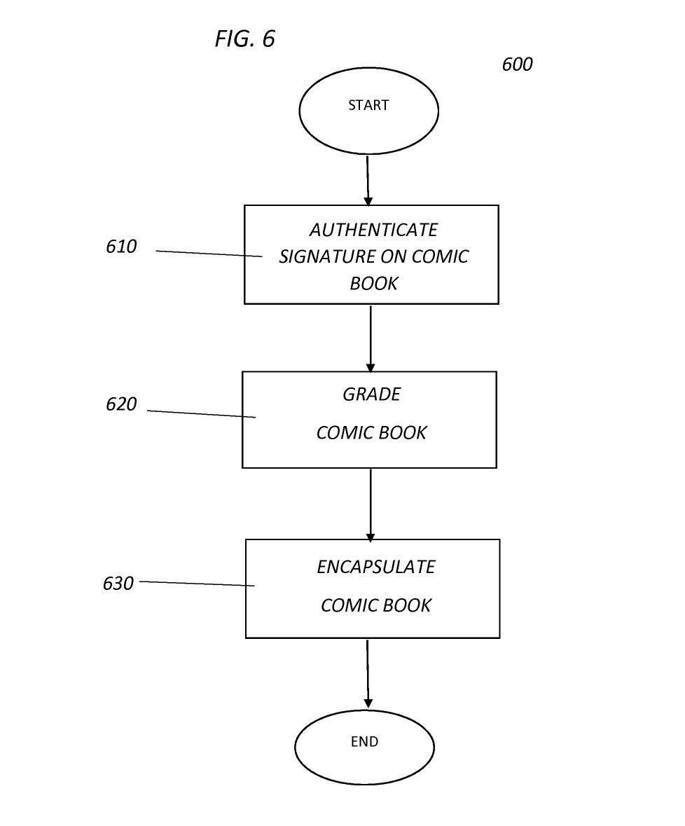

Turning now to FIG. 6, in another particular illustrative embodiment 600, a method for authenticating a signature on a comic book is disclosed. As shown in FIG. 6, at 610 a signature on a comic book is authenticated. At 620 the comic book is graded. At 630 the comic book is encapsulated.

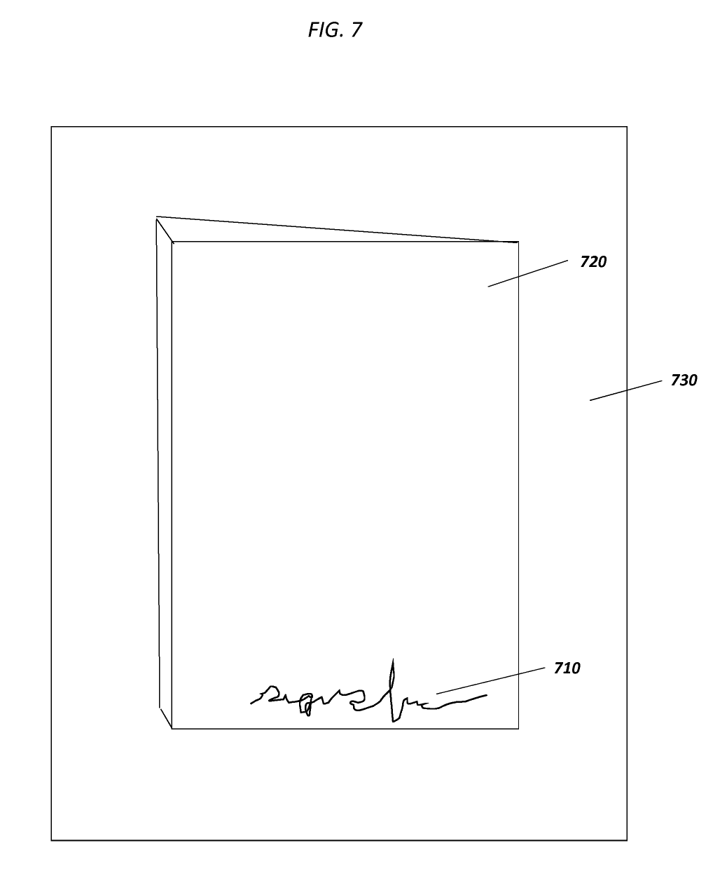

Turning now to FIG. 7, FIG. 7 is a schematic depiction of an illustrative embodiment of the invention showing a comic book 720 with an authenticated signature 710 encapsulated in a case 730.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived there from, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. A method comprising:
authenticating a signature on a comic book.

2. The method of claim 1, further comprising:
grading the comic book.

3. The method of claim 1, further comprising:
encapsulating the comic book.

4. The method of claim 2, further comprising:
encapsulating the comic book.

5. An apparatus comprising:
a comic book having an authenticated signature; and
a case encapsulating the comic book.
